(19) United States
(12) Patent Application Publication
(10) Pub. No.: US 2006/0147201 A1
(43) Pub. Date: Jul. 6, 2006

(54) Substrate processing apparatus and substrate processing method

(75) Inventors: Toru Asano, Kamigyo-ku (JP); Yukio Toriyama, Kamigyo-ku (JP); Takashi Taguchi, Kamigyo-ku (JP); Tsuyoshi Mitsuhashi, Kamigyo-ku (JP); Koji Kaneyama, Kamigyo-ku (JP); Tsuyoshi Okumura, Kamigyo-ku (JP)

Correspondence Address: OSTROLENK FABER GERB & SOFFEN, 1180 AVENUE OF THE AMERICAS, NEW YORK, NY, 100368403, US

(73) Assignee: Dainippon Screen Mfg. Co., Ltd.

(21) Appl. No.: 11/294,877

(22) Filed: Dec. 6, 2005

(30) Foreign Application Priority Data
Dec. 6, 2004 (JP) 2004-353117
Mar. 29, 2005 (JP) 2005-095780

(51) Int. Cl. G03D 5/00

(52) U.S. Cl. 396/611

(57) ABSTRACT

An interface transport mechanism employs an upper hand during the transport of a substrate to an exposure device, and employs a lower hand during the transport of the substrate that has been carried out of the exposure device. A fifth central robot employs a lower hand during the transport of a substrate after the exposure processing by an exposure device, and employs an upper hand during the transport of a substrate after the drying processing that has been carried out of a drying processing group. That is, the upper hand is employed to transport a substrate to which no liquid is attached, and the lower hand is employed to transport a substrate to which a liquid is attached after the exposure processing.

### BACKGROUND OF THE INVENTION

1. Field of the Invention

The present invention relates to a substrate processing apparatus and a substrate processing method for applying processing to substrates.

2. Description of the Background Art

A substrate processing apparatus is used to apply a variety of processing to substrates such as semiconductor substrates, substrates for use in liquid crystal displays, plasma displays, optical disks, magnetic disks, magneto-optical disks, photomasks, and other substrates.

Such a substrate processing apparatus typically applies a plurality of successive processing to a single substrate. The substrate processing apparatus as described in JP 2003-324139 A comprises an indexer block, an anti-reflection film processing block, a resist film processing block, a development processing block, and an interface block. An exposure device is arranged adjacent to the interface block as an external device separate from the substrate processing apparatus.

In the above-described substrate processing apparatus, a substrate is carried from the indexer block into the anti-reflection film processing block and the resist film processing block, where the formation of an anti-reflection film and resist film coating processing are applied to the substrate. The substrate is then transported to the exposure device through the interface block. After exposure processing has been applied to the resist film on the substrate by the exposure device, the substrate is transported to the development processing block through the interface block. In the development processing block, development processing is applied to the resist film on the substrate to form a resist pattern thereon, and the substrate is subsequently carried into the indexer block.

In this substrate processing apparatus, a single holding arm of an interface transport mechanism transports the substrate from the interface block to the exposure device and from the exposure device to the interface block.

With recent improvements in the density and integration of devices, making finer resist patterns have become very important. Conventional exposure devices typically perform exposure processing by providing reduction projection of a reticle pattern on a substrate through a projection lens. With such conventional exposure devices, however, the line width of an exposure pattern is determined by the wavelength of the light source of an exposure device, thus making it impossible to make a resist pattern finer than that.

For this reason, a liquid immersion method is suggested as a projection exposure method allowing for finer exposure patterns (refer to, e.g., WO99/49504 pamphlet). In the projection exposure device according to the WO 99/49504 pamphlet, a liquid is filled between a projection optical system and a substrate, resulting in a shorter wavelength of exposure light on a surface of the substrate. This allows for a finer exposure pattern.

However, in the projection exposure device according to the aforementioned WO99/49504 pamphlet, exposure processing is performed with the substrate and the liquid being in contact with each other. Accordingly, the substrate to which the liquid is attached is transported out of the projection exposure device.

Thus, when combining the substrate processing apparatus according to the aforementioned JP 2003-324139 A with the projection exposure device according to the aforementioned WO99/49504 pamphlet as an external device, the liquid attached to the substrate that is carried out of the projection exposure device settles on the holding arm. Since the holding arm also transports a substrate before the exposure processing to the projection exposure device, the liquid settled on the holding arm attaches also to the back surface of the substrate before the exposure processing.

Therefore, during the transport of the substrate to the projection exposure device, particles and the like in the atmosphere attach to the liquid on the back surface of the substrate, and contaminate the back surface of the substrate. This may result in degraded resolution performance during the exposure processing due to the contamination of the back surface of the substrate.

### SUMMARY OF THE INVENTION

It is an object of the invention to provide a substrate processing apparatus and a substrate processing method in which contamination of back surfaces of substrates can be sufficiently prevented.

(1)

A substrate processing apparatus according to one aspect of the invention that is arranged adjacent to an exposure device comprises a processing section for applying processing to a substrate, and an interface for exchanging the substrate between the processing section and the exposure device, wherein the processing section includes a first processing unit that dries the substrate, and the interface includes a platform on which the substrate is temporarily mounted, a first transport unit that transports the substrate between the processing section and the platform, a second transport unit that transports the substrate between the platform and the exposure device and a third transport unit that transports the substrate between the platform and the first processing unit, and wherein the second transport unit includes first and second holders for holding the substrate, and holds the substrate with the first holder during the transport of the substrate from the platform to the exposure device, and holds the substrate with the second holder during the transport of the substrate from the exposure device to the platform, the third transport unit includes third and fourth holders for holding the substrate, and holds the substrate with the third holder during the transport of the substrate from the first processing unit to the platform, and holds the substrate with the fourth holder during the transport of the substrate from the platform to the first processing unit.

In the substrate processing apparatus, the substrate is subjected to given processing by the processing section, and then transported to the platform by the first transport unit. Then, the substrate is transported to the exposure device while being held by the first holder of the second transport unit. After the substrate is subjected to exposure processing by the exposure device, the substrate is transported to the platform while being held by the second holder of the second transport unit. Then, the substrate is transported to the first processing unit while being held by the fourth holder of the third transport unit. The substrate is dried by the first processing unit, and subsequently transported to the platform while being held by the third holder of the third transport unit. Then, the substrate is transported to the processing section by the first transport unit.

In this way, the substrate after the exposure processing is dried by the first processing unit, and then transported to the processing section by the first transport unit. Therefore, even if a liquid attaches to the substrate in the exposure device, the liquid on the substrate after the exposure processing will not attach to the first transport unit.

In addition, the second transport unit holds the substrate with the first holder during the transport of the substrate from the platform to the exposure device, and holds the substrate with the second holder during the transport of the substrate from the exposure device to the platform. That is to say, the substrate is held by the first holder during the transport of the substrate to which a liquid is not attached before the exposure processing, and the substrate is held by the second holder during the transport of the substrate to which a liquid is attached after the exposure processing. This prevents the liquid on the substrate after the exposure processing from attaching to the first holder.

Moreover, the third transport unit holds the substrate with the third holder during the transport of the substrate from the first processing unit to the platform, and holds the substrate with the fourth holder during the transport of the substrate from the platform to the first processing unit. That is to say, the substrate is held by the third holder during the transport of the substrate to which a liquid is not attached after the drying processing by the first processing unit, and the substrate is held by the fourth holder during the transport of the substrate to which a liquid is attached after the exposure processing by the exposure device and before the drying processing by the first processing unit. This prevents the liquid on the substrate after the exposure processing from attaching to the third holder.

As a result, a liquid is prevented from attaching to the substrate before the exposure processing, which sufficiently prevents contamination of the back surface of the substrate due to the attachment of particles and the like to the liquid. It is thus possible to prevent processing defects due to degradation in the resolution performance or the like in the exposure device.

Furthermore, the substrate is subjected to given drying processing by the first processing unit immediately after the exposure processing, which prevents a liquid attached to the substrate from dropping in the substrate processing apparatus. This prevents operational troubles such as abnormalities in the electric system of the substrate processing apparatus.

(2)

The second holder may be provided below the first holder. In this case, even if a liquid drops from the second holder and the substrate held thereon, the liquid will not attach to the first holder and the substrate held thereon. The liquid is thus reliably prevented from attaching to the substrate before the exposure processing.

(3)

The fourth holder may be provided below the third holder. In this case, even if a liquid drops from the fourth holder and the substrate held thereon, the liquid will not attach to the third holder and the substrate held thereon. The liquid is thus reliably prevented from attaching to the substrate after the drying processing.

(4)

The interface may further include a second processing unit that applies given processing to the substrate, and the first transport unit may transport the substrate between the processing section, the second processing unit, and the platform.

In this case, the substrate is subjected to given processing by the processing section, and then transported to the second processing unit by the first transport unit. After the substrate is subjected to given processing by the second processing unit, the substrate is transported to the platform by the first transport unit.

In this way, the disposition of the second processing unit in the interface enables the addition of processing contents without increasing the footprint of the substrate processing apparatus.

(5)

The second processing unit may include an edge exposure unit for subjecting a peripheral portion of the substrate to exposure. In this case, the peripheral portion of the substrate is subjected to the exposure processing by the edge exposure unit.

(6)

The processing section may further include a third processing unit that forms a photosensitive film made of a photosensitive material on the substrate.

In this case, the substrate is dried by the first processing unit after an exposure pattern has been formed on the photosensitive film by the exposure device. This prevents the components of the photosensitive material from being eluted in the liquid attached to the substrate during exposure. This prevents the deformation of the exposure pattern formed on the photosensitive film. As a result, processing defects of the substrate are prevented.

(7)

The first processing unit may further clean the substrate before drying the substrate.

In this case, even if a liquid attaches to the substrate during exposure, and particles and the like in the atmosphere attach to the substrate while being transported from the exposure device to the first processing unit, the deposits can be removed reliably. This reliably prevents processing defects of the substrate.

(8)

The first processing unit may comprise a substrate holding device that holds the substrate substantially horizontally, a rotation-driving device that rotates the substrate held on the substrate holding device about an axis vertical to the substrate, a cleaning liquid supplier that supplies a cleaning liquid onto the substrate held on the substrate holding device and an inert gas supplier that supplies an inert gas onto the substrate after the cleaning liquid has been supplied onto the substrate by said cleaning liquid supplier.

In the first processing unit, the substrate is held on the substrate holding device substantially horizontally, and the substrate is rotated about the axis vertical to the substrate by the rotation-driving device. Then, the cleaning liquid is supplied onto the substrate from the cleaning liquid supplier, followed by the supply of the inert gas from the inert gas supplier.

In this case, since the substrate is rotated as the cleaning liquid is supplied onto the substrate, the cleaning liquid on the substrate moves toward the peripheral portion of the substrate by the centrifugal force and splashed away. This reliably prevents the deposits of particles and the like removed by the cleaning liquid from remaining on the substrate. In addition, since the substrate is rotated as the inert gas is supplied onto the substrate, the cleaning liquid remaining on the substrate after the cleaning of the substrate is efficiently removed. This reliably prevents the deposits of particles and the like from remaining on the substrate and the substrate is reliably dried. As a result, processing defects of the substrate are prevented reliably.

(9)

The inert gas supplier may supply the inert gas so that the cleaning liquid supplied onto the substrate from the cleaning liquid supplier is removed from the substrate as the cleaning liquid moves outwardly from the center of the substrate.

This prevents the cleaning liquid from remaining on the center of the substrate, thus reliably preventing the generation of dry marks (dry stains) on a surface of the substrate. As a result, processing defects of the substrate are prevented reliably.

(10)

The first processing unit may further comprise a rinse liquid supplier that supplies a rinse liquid onto the substrate after the supply of the cleaning liquid from said cleaning liquid supplier and before the supply of the inert gas from said inert gas supplier.

This allows the cleaning liquid to be reliably cleaned away by the rinse liquid, thus reliably preventing the deposits of particles and the like from remaining on the substrate.

(11)

The inert gas supplier may supply the inert gas so that the rinse liquid supplied onto the substrate from the rinse liquid supplier is removed from the substrate as the rinse liquid moves outwardly from the center of the substrate.

This prevents the rinse liquid from remaining on the center of the substrate, thus reliably preventing the generation of dry marks on the surface of the substrate. Accordingly, processing defects of the substrate are prevented reliably.

(12)

The processing section may include a chemical solution processing unit that treats the substrate with a chemical solution, and a thermal processing unit that thermally treats the substrate.

In this case, the substrate is subjected to given treatment with a chemical solution by the chemical solution processing unit, and subjected to given thermal treatment by the thermal processing unit. The substrate after the exposure processing is dried by the first processing unit, and then transported to the chemical solution processing unit and the thermal processing unit. Therefore, even if a liquid attaches to the substrate in the exposure device, the liquid will not drop into the chemical solution processing unit and the thermal processing unit.

(13)

A substrate processing method according to another aspect of the present invention for processing a substrate in a substrate processing apparatus that is arranged adjacent to an exposure device and comprises a processing section, a first transport unit, a second transport unit that includes first and second holders, a third transport unit that includes third and fourth holders, a first processing unit, and a platform comprises the steps of applying given processing to a substrate by said processing section, transporting the substrate that has been processed by the processing section to the platform by means of the first transport unit, transporting the substrate from the platform to the exposure device while holding the substrate by the first holder of the second transport unit, transporting the substrate that has been carried out of the exposure device to the platform while holding the substrate by the second holder of the second transport unit, transporting the substrate from the platform to the first processing unit while holding the substrate by the fourth holder of the third transport unit, drying the substrate by the first processing unit, transporting the substrate that has been carried out of the first processing unit to the platform while holding the substrate by the third holder of the third transport unit, and transporting the substrate from the platform to the processing section by means of the first transport unit.

In the substrate processing method, the substrate is subjected to given processing by the processing section, and then transported to the platform by the first transport unit. Then, the substrate is transported to the exposure device while being held by the first holder of the second transport unit. After the substrate is subjected to exposure processing by the exposure device, the substrate is transported to the platform while being held by the second holder of the second transport unit. Then, the substrate is transported to the first processing unit while being held by the fourth holder of the third transport unit. The substrate is dried by the first processing unit, and subsequently transported to the platform while being held by the third holder of the third transport unit. Then, the substrate is transported to the processing section by the first transport unit.

In this way, the substrate after the exposure processing is dried by the first processing unit, and then transported to the processing section by first transport unit. Therefore, even if a liquid attaches to the substrate in the exposure device, the liquid on the substrate after the exposure processing will not attach to the first transport unit.

In addition, the second transport unit holds the substrate with the first holder during the transport of the substrate from the platform to the exposure device, and holds the substrate with the second holder during the transport of the substrate from the exposure device to the platform. That is to say, the substrate is held by the first holder during the transport of the substrate to which a liquid is not attached before the exposure processing, and the substrate is held by the second holder during the transport of the substrate to which a liquid is attached after the exposure processing. This prevents the liquid on the substrate after the exposure processing from attaching to the first holder.

Moreover, the third transport unit holds the substrate with the third holder during the transport of the substrate from the first processing unit to the platform, and holds the substrate with the fourth holder during the transport of the substrate from the platform to the first processing unit. That is to say, the substrate is held by the third holder during the transport of the substrate to which a liquid is not attached after the drying processing by the first processing unit, and the substrate is held by the fourth holder during the transport of the substrate to which a liquid is attached after the exposure processing by the exposure device and before the drying processing by the first processing unit. This prevents the liquid on the substrate after the exposure processing from attaching to the third holder.

As a result, a liquid is prevented from attaching to the substrate before the exposure processing, which sufficiently prevents contamination of the back surface of the substrate due to the attachment of particles and the like to the liquid. It is thus possible to prevent processing defects due to degradation in the resolution performance or the like in the exposure device.

(14)

The method may further comprise the step of cleaning the substrate by the first processing unit, after the step of transporting the substrate from the platform to the first processing unit by the third transport unit and before the step of drying the substrate by the first processing unit.

Since the exposed substrate is thus cleaned by the first processing unit, even if a liquid attaches to the substrate during exposure, and particles and the like in the atmosphere attach to the substrate during the transport of the substrate from the exposure device to the first processing unit, the deposits can be removed reliably. Accordingly, processing defects of the substrate are prevented reliably.

According to the invention, a liquid is prevented from attaching to the substrate before the exposure processing, which sufficiently prevents contamination of the back surface of the substrate due to the attachment of particles and the like to the liquid. It is thus possible to prevent processing defects due to degradation in the resolution performance or the like in the exposure device.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic plan view of a substrate processing apparatus according to an embodiment of the invention;

FIG. 2 is a side view of the substrate processing apparatus in FIG. 1 that is seen from the +X direction;

FIG. 3 is a side view of the substrate processing apparatus in FIG. 1 that is seen from the −X direction;

FIG. 4 is a diagram for use in illustrating the configuration of a drying processing unit;

FIGS. 5(a), 5(b), and 5(c) are diagrams for use in illustrating the operation of the drying processing unit;

FIG. 6 is a schematic diagram of a nozzle in which a nozzle for cleaning processing and a nozzle for drying processing are formed integrally;

FIG. 7 is a schematic diagram showing another example of the nozzle for drying processing;

FIGS. 8(a), 8(b), and 8(c) are diagrams for use in illustrating a method of applying drying processing to a substrate using the nozzle in FIG. 7;

FIG. 9 is a schematic diagram showing another example of the nozzle for drying processing;

FIG. 10 is a schematic diagram showing another example of the drying processing unit;

FIG. 11 is a diagram for use in illustrating a method of applying drying processing to the substrate using the drying processing unit in FIG. 10; and

FIG. 12 is a diagram for use in illustrating the configuration and the operation of the fifth central robot and the interface transport mechanism.

### DESCRIPTION OF THE PREFERRED EMBODIMENTS

A substrate processing apparatus according to an embodiment of the invention will be described with reference to the drawings. A substrate as used in the specification includes a semiconductor substrate, a substrate for a liquid crystal display, a substrate for a plasma display, a glass substrate for a photomask, a substrate for an optical disk, a substrate for a magnetic disk, a substrate for a magneto-optical disk, and a substrate for a photomask.

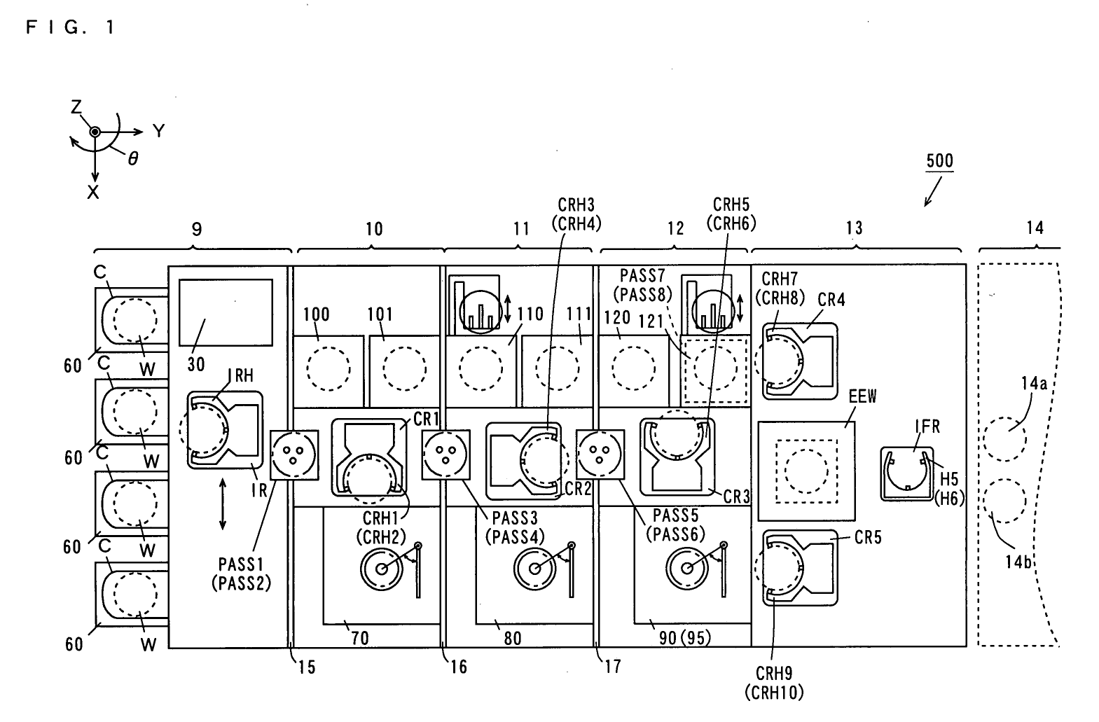

FIG. 1 is a plan view of the semiconductor laser apparatus according to the embodiment of the invention.

Each of FIG. 1 and the subsequent drawings is accompanied by the arrows that indicate X, Y, and Z directions perpendicular to one another for clarification of positions. The X and Y directions are perpendicular to each other in a horizontal plane, and the Z direction corresponds to the vertical direction. In each of the directions, the direction toward an arrow is defined as + direction, and the opposite direction is defined as − direction. The rotation direction about the Z direction is defined as θ direction.

As shown in FIG. 1, the substrate processing apparatus 500 includes an indexer block 9, an anti-reflection film processing block 10, a resist film processing block 11, a drying/development processing block 12, and an interface block 13. An exposure device 14 is arranged adjacent to the interface block 13. The exposure device 14 applies exposure processing to substrates W by a liquid immersion method.

Each of the indexer block 9, anti-reflection film processing block 10, resist film processing block 11, drying/development processing block 12, and interface block 13 will hereinafter be referred to as a processing block.

The indexer block 9 includes a main controller (controller) 30 for controlling the operation of each processing block, a plurality of carrier platforms 60, and an indexer robot IR. The indexer robot IR has a hand IRH for receiving and transferring the substrates W.

The anti-reflection film processing block 10 includes thermal processing groups 100, 101 for anti-reflection film, a coating processing group 70 for anti-reflection film, and a first central robot CR1. The coating processing group 70 is arranged opposite to the thermal processing groups 100, 101 with the first central robot CR1 therebetween. The first central robot CR1 has hands CRH1, CRH2 provided one above the other for receiving and transferring the substrates W.

A partition wall 15 is arranged between the indexer block 9 and the anti-reflection film processing block 10 for shielding an atmosphere. The partition wall 15 has substrate platforms PASS1, PASS2 provided closely one above the other for receiving and transferring the substrates W between the indexer block 9 and the anti-reflection film processing block 10. The upper substrate platform PASS1 is used in transferring the substrates W from the indexer block 9 to the anti-reflection film processing block 10, and the lower substrate platform PASS2 is used in transferring the substrates W from the anti-reflection film processing block 10 to the indexer block 9.

Each of the substrate platforms PASS1, PASS2 has an optical sensor (not shown) for detecting the presence or absence of a substrate W. This enables a determination to be made whether or not a substrate W is on the substrate platform PASS1, PASS2. In addition, each of the substrate platforms PASS1, PASS2 has a plurality of support pins secured thereto. Note that each of substrate platforms PASS3 to PASS12 mentioned below similarly has such optical sensor and support pins.

The resist film processing block 11 includes thermal processing groups 110, 111 for resist film, a coating processing group 80 for resist film, and a second central robot CR2. The coating processing group 80 is arranged opposite to the thermal processing groups 110, 111 with the second central robot CR2 therebetween. The second central robot CR2 has hands CRH3, CRH4 provided one above the other for receiving and transferring the substrates W.

A partition wall 16 is arranged between the anti-reflection film processing block 10 and the resist film processing block 11 for shielding an atmosphere. The partition wall 16 has substrate platforms PASS3, PASS4 provided closely one above the other for receiving and transferring the substrates W between the anti-reflection film processing block 10 and the resist film processing block 11. The upper substrate platform PASS3 is used in transferring the substrates W from the anti-reflection film processing block 10 to the resist film processing block 11. The lower substrate platform PASS4 is used in transferring the substrates W from the resist film processing block 11 to the anti-reflection film processing block 10.

The drying/development processing block 12 includes thermal processing groups 120, 121 for development, a development processing group 90, a drying processing group 95, and a third central robot CR3. The thermal processing group 121, adjacent to the interface block 13, has substrate platforms PASS7, PASS8 as described below. The development processing group 90 and the drying processing group 95 are arranged opposite to the thermal processing groups 120, 121 with the third central robot CR3 therebetween. The third central robot CR3 has hands CRH5, CRH6 provided one above the other for receiving and transferring the substrates W.

A partition wall 17 is arranged between the resist film processing block 11 and the drying/development processing block 12 for shielding an atmosphere. The partition wall 17 has substrate platforms PASS5, PASS6 provided closely one above the other for receiving and transferring the substrates W between the resist film processing block 11 and the drying/development processing block 12. The upper substrate platform PASS5 is used in transferring the substrates W from the resist film processing block 11 to the drying/development processing block 12, and the lower substrate platform PASS6 is used in transferring the substrates W from the drying/development processing block 12 to the resist film processing block 11.

The interface block 13 includes a fourth central robot CR4, a fifth central robot CR5, an interface transport mechanism IFR, and edge exposure units EEW. Substrate platforms PASS9, PASS10, PASS11, PASS12, a return buffer unit RBF, and a feed buffer unit SBF are provided under the edge exposure units EEW as described below. The fourth central robot CR4 has hands CRH7, CRH8 provided one above the other for receiving and transferring the substrates W. The interface transport mechanism IFR has hands H5, H6 for receiving and transferring the substrates W.

In the substrate processing apparatus 500 of the embodiment, the indexer block 9, the anti-reflection film processing block 10, resist film processing block 11, drying/development processing block 12, and interface block 13 are sequentially arranged in parallel along the Y direction.

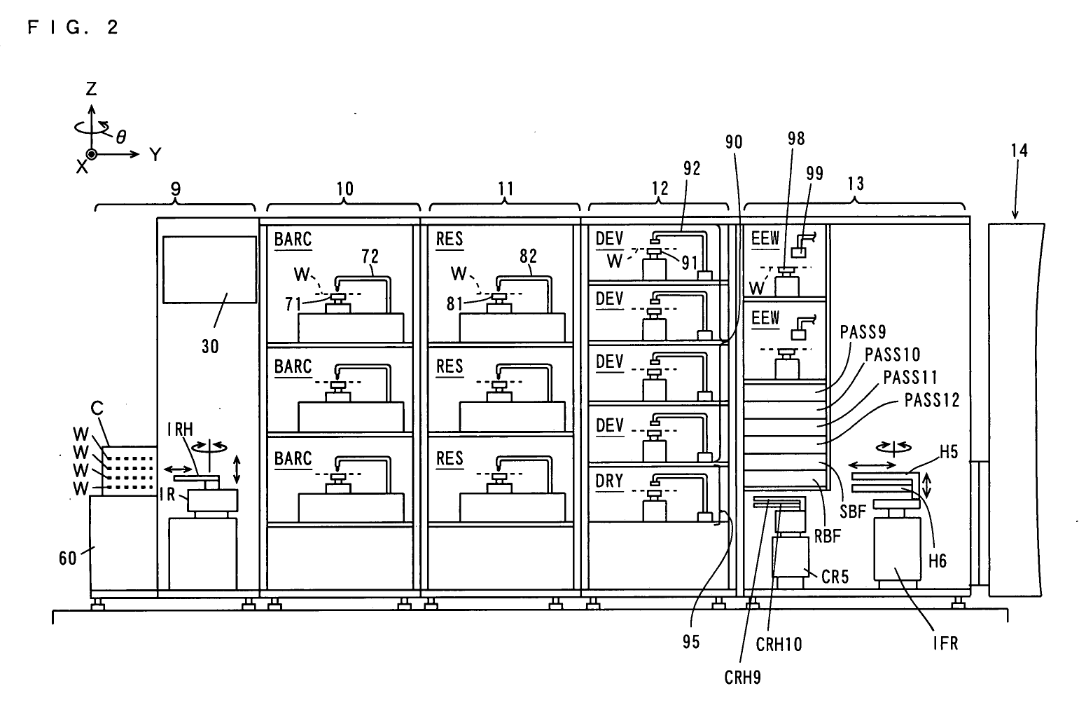

FIG. 2 is a side view of the substrate processing apparatus 500 in FIG. 1 that is seen from the +X direction.

The coating processing group 70 in the anti-reflection film processing block 10 (see FIG. 1) includes a vertical stack of three coating units BARC. Each of the coating units BARC comprises a spin chuck 71 for rotating a substrate W while holding the substrate Win a horizontal attitude by suction, and a supply nozzle 72 for supplying coating liquid for an anti-reflection film to the substrate W held on the spin chuck 71.

The coating processing group 80 in the resist film processing block 11 (see FIG. 1) includes a vertical stack of three coating units RES. Each of the coating units RES comprises a spin chuck 81 for rotating a substrate W while holding the substrate W in a horizontal attitude by suction, and a supply nozzle 82 for supplying coating liquid for a resist film to the substrate W held on the spin chuck 81.

The drying/development processing block 12 includes a vertical stack of the development processing group 90 and the drying processing group 95. The development processing group 90 includes a vertical stack of four development processing units DEV. Each of the development processing units DEV comprises a spin chuck 91 for rotating a substrate W while holding the substrate W in a horizontal attitude by suction, and a supply nozzle 92 for supplying development liquid to the substrate W held on the spin chuck 91.

The drying processing group 95 includes a vertical stack of a drying processing unit DRY. The drying processing unit DRY applies cleaning and drying processing to the substrates W. The drying processing unit DRY will be described in detail below.

The interface block 13 includes, on the drying/development processing block 12 side thereof, a vertical stack of the two edge exposure units EEW, the substrate platforms PASS9, PASS10, PASS11, PASS12, the feed buffer SBF, and the return buffer RBF, and as well as the fourth central robot CR4 (see FIG. 1), and the fifth central robot CR5. Each of the edge exposure units EEW comprises a spin chuck 98 for rotating a substrate W in a horizontal attitude by suction, and a light irradiator 99 for subjecting a peripheral portion of the substrate W held on the spin chuck 98 to exposure.

The interface block 13 also includes, on the exposure device 14 side thereof, the interface transport mechanism IFR.

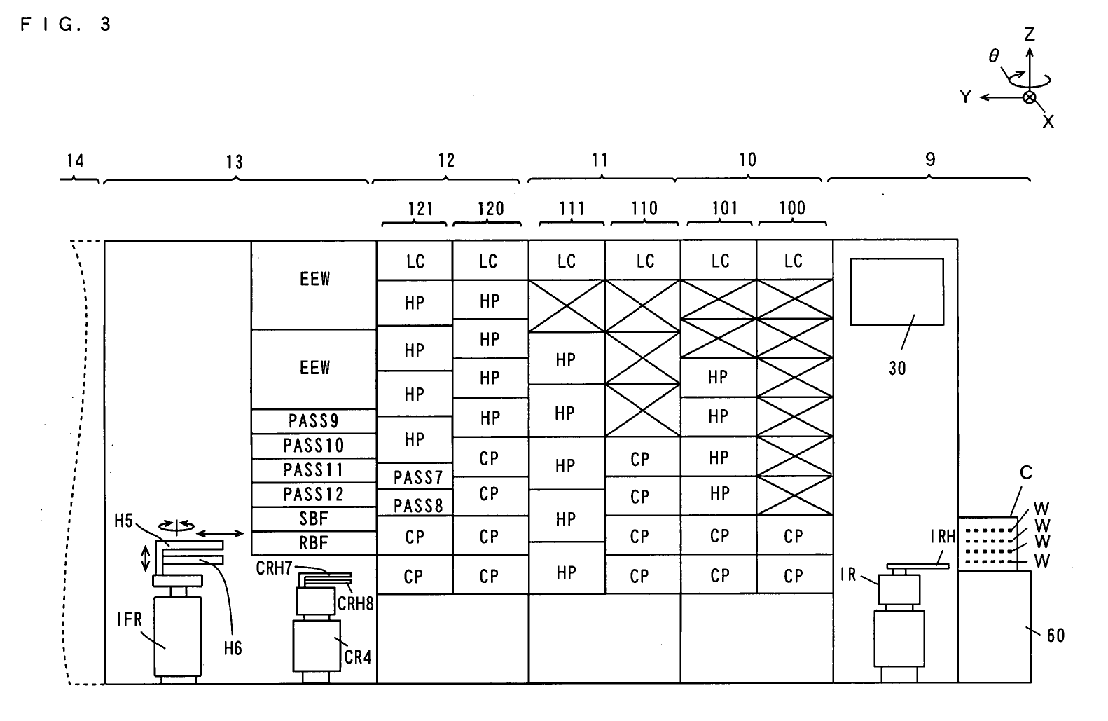

FIG. 3 is a side view of the substrate processing apparatus 500 in FIG. 1 that is seen from the −X direction.

In the anti-reflection film processing block 10, the thermal processing group 100 includes a vertical stack of two cooling units (cooling plates) CP, and the thermal processing group 101 includes a vertical stack of four heating units (hot plates) HP and two cooling units CP. The thermal processing group 100 also includes a local controller LC on top thereof for controlling the temperatures of the cooling units CP, and the thermal processing group 101 also includes a local controller LC on top thereof for controlling the temperatures of the heating units HP and the cooling plates CP.

In the resist film processing block 11, the thermal processing group 110 includes a vertical stack of four cooling units CP, and the thermal processing group 111 includes a vertical stack of five heating units HP. The thermal processing group 110 also includes a local controller LC on top thereof for controlling the temperatures of the cooling units CP, and the thermal processing group 111 also includes a local controller LC on top thereof for controlling the temperatures of the heating units HP.

In the drying/development processing block 12, the thermal processing group 120 includes a vertical stack of four heating units HP and four cooling units CP, and the thermal processing group 121 includes a vertical stack of four heating units HP, substrate platforms PASS7, PASS8, and two cooling units CP. The thermal processing group 120 also includes a local controller LC on top thereof for controlling the temperatures of the heating units HP and the cooling units CP, and the thermal processing group 121 also includes a local controller LC for controlling the temperatures of the heating units HP and the cooling units CP.

Next, the operation of the substrate processing apparatus 500 in this embodiment will be described.

Carriers C for storing the substrates W in multiple stages are mounted on the carrier platforms 60, respectively, in the indexer block 9. The indexer robot IR takes out a substrate W yet to be processed which is stored in a carrier C using the hand IRH. Then, the indexer robot IR moves in the ±X direction while rotating in the ±θ direction to transfer the unprocessed substrate W onto the substrate platform PASS1.

Although FOUPs (Front Opening Unified Pods) are adopted as the carriers C in this embodiment, SMIF (Standard Mechanical Inter Face) pods or OCs (Open Cassettes) that expose stored substrates W to outside air may also be used, for example. In addition, although linear-type transport robots that move their hands forward or backward by sliding them linearly to a substrate W are used as the indexer robot IR, the first central robot CR1 to the fifth central robot CR5, and the interface transport mechanism IFR, multi-joint type transport robots that linearly move their hands forward and backward by moving their joints may also be used.

The unprocessed substrate W that has been transferred onto the substrate platform PASS1 is carried to the thermal processing group 100 or 101 by the first central robot CR1 in the anti-reflection film processing block 10.

After this, the first central robot CR1 takes out the thermally treated substrate W from the thermal processing group 100 or 101, and then carries the substrate W to the coating processing group 70. The coating processing group 70 forms a coating of an anti-reflection film on a substrate W using a coating unit BARC, in order to reduce potential standing waves and halation generated during exposure.

The first central robot CR1 subsequently takes out the substrate W after the coating processing from the coating processing group 70, and carries the substrate W to the thermal processing group 100 or 101. Then, the first central robot CR1 takes out the thermally treated substrate W from the thermal processing group 100 or 101, and transfers the substrate W to the substrate platform PASS3.

The substrate W that has been transferred on to the substrate platform PASS3 is carried to the thermal processing group 110 or 111 by the second central robot CR2 in the resist film processing block 11.

The second central robot CR2 then takes out the thermally treated substrate W from the thermal processing group 110 or 111, and transfers the substrate W to the coating processing group 80. The coating processing group 80 forms a coating of a photoresist film over the substrate W coated with the anti-reflection film by a coating unit RES.

After this, the second central robot CR2 takes out the substrate W after the coating processing from the coating processing group 80, and carries the substrate W to the thermal processing group 110 or 111. Then, the second central robot CR2 takes out the thermally treated substrate W from the thermal processing group 110 or 111, and transfers the substrate W onto the substrate platform PASS5.

The substrate W that has been transferred on to the substrate platform PASS5 is carried to the substrate platform PASS7 by the third central robot CR3 in the drying/development processing block 12. The substrate W that has been transferred on to the substrate platform PASS7 is carried to an edge exposure unit EEW by the fourth central robot CR4 in the interface block 13. The edge exposure unit EEW applies exposure processing to the peripheral portion of the substrate W.

Then, the fourth central robot CR4 transfers the substrate W after the edge exposure processing from the edge exposure unit EEW to the substrate platform PASS9.

The substrate W on the substrate platform PASS9 is transferred onto the feed buffer unit SBF by the fifth central robot CR5. Then, the fifth central robot CR5 transfers the substrate W from the feed buffer unit SBF to the substrate platform PASS11.

The substrate W on the substrate platform PASS1 is carried into the exposure device 14 by the interface transport mechanism IFR. After exposure processing has been applied to the substrate W by the exposure device 14, the interface transport mechanism IFR transfers the substrate W to the substrate platform PASS12.

The substrate W on the substrate platform PASS12 is carried to the drying processing group 95 by the fifth central robot CR5. As described above, the drying processing group 95 applies cleaning and drying processing to the substrates W by a drying processing unit DRY. Then, the fifth central robot CR5 transfers the substrate W after the drying processing from the drying processing group 95 to the substrate platform PASS10. The fifth central robot CR5 and the interface transport mechanism IFR will be described below.

The substrate W on the substrate platform PASS10 is carried into the thermal processing group 121 in the drying/development processing block 12 by the fourth central robot CR4 in the interface block 13. The substrate W is subjected to a post-exposure bake (PEB) by the thermal processing group 121. Then, the fourth central robot CR4 transfers the substrate W from the thermal processing group 121 to the substrate platform PASS8.

The substrate Won the substrate platform PASS8 is received by the third central robot CR3 in the drying/development processing block 12. The third central robot CR3 carries the substrate W into the development processing group 90. The development processing group 90 applies development processing to the exposed substrate W by a development processing unit DEV.

After this, the third central robot CR3 takes out the substrate W after the development processing from the development processing group 90, and transfers the substrate W to the thermal processing group 120.

Then, the third central robot CR3 takes out the thermally treated substrate W from the thermal processing group 120, and transfers the substrate W onto the substrate platform PASS6 in the resist film processing block 11.

If the development processing group 90 is temporarily not capable of applying development processing to the substrate W by, e.g., a failure, the substrate W may temporarily be stored in the return buffer RBF in the interface block 13 after the post-exposure bake in the thermal processing group 121.

The substrate W on the substrate platform PASS6 is transferred onto the substrate platform PASS4 by the second central robot CR2 in the resist film processing block 11. The substrate W on the substrate platform PASS4 is transferred onto the substrate platform PASS2 by the first central robot CR1 in the anti-reflection film processing block 10.

The substrate W on the substrate platform PASS2 is stored in a carrier C by the indexer robot IR in the indexer block 9. Each of the processing to the substrate W in the substrate processing apparatus is thus completed.

Now, the aforementioned drying processing units DRY will be described in detail with reference to the drawings.

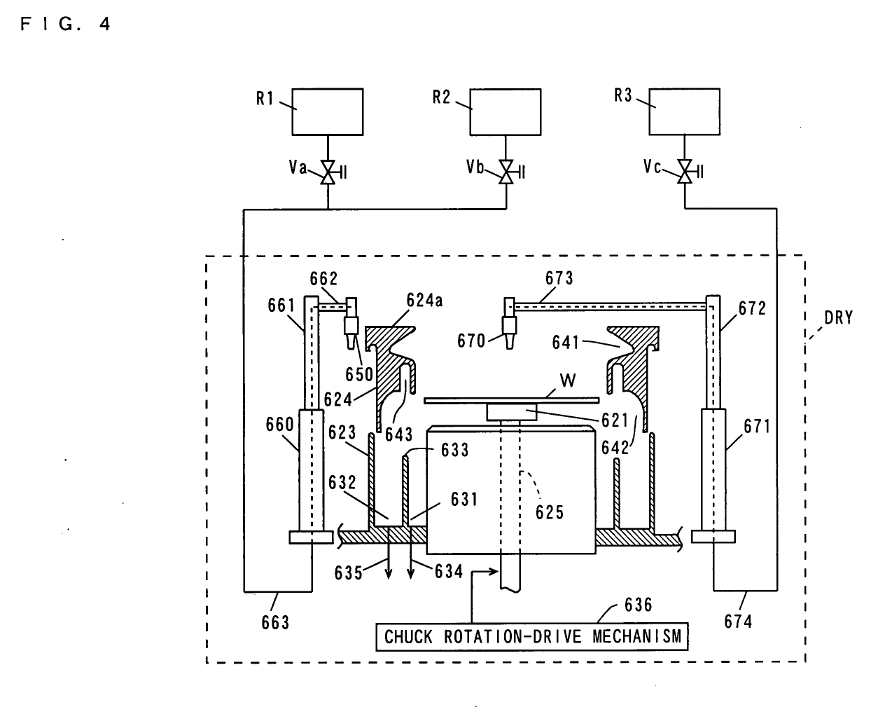

The configuration of a drying processing unit DRY is first described. FIG. 4 is a diagram for use in illustrating the configuration of the drying processing unit DRY.

As shown in FIG. 4, the drying processing unit DRY comprises a spin chuck 621 for rotating a substrate W about the vertical rotation axis passing through the center of the substrate W while horizontally holding the substrate W.

The spin chuck 621 is secured to an upper end of a rotation shaft 625, which is rotated via a chuck rotation-drive mechanism 636. An air suction passage (not shown) is formed in the spin chuck 621. With the substrate W being mounted on the spin chuck 621, air inside the air suction passage is discharged, so that a lower surface of the substrate W is sucked onto the spin chuck 621 by vacuum, and the substrate W is held in a horizontal attitude.

A first rotation motor 660 is arranged outside the spin chuck 621. The first rotation motor 660 is connected to a first rotation shaft 661. The first rotation shaft 661 is coupled to a first arm 662, which extends in the horizontal direction, and whose end is provided with a nozzle 650 for cleaning processing.

The first rotation shaft 661 is rotated by the first rotation motor 660, so that the first arm 662 swings. This causes the nozzle 650 to move above the substrate W held on the spin chuck 621.

A supply pipe 663 for cleaning processing is arranged so as to pass through the inside of the first rotation motor 660, first rotation shaft 661, and first arm 662. The supply pipe 663 is connected to a cleaning liquid supply source R1 and a rinse liquid supply source R2 through a valve Va and a valve Vb, respectively. Controlling the opening and closing of the valves Va, Vb allows the selection of the processing liquid supplied to the supply pipe 663 and adjustments of the amount thereof. In the configuration of FIG. 4, when the valve Va is opened, cleaning liquid is supplied to the supply pipe 663, and when the valve Vb is opened, rinse liquid is supplied to the supply pipe 663.

The cleaning liquid or the rinse liquid is supplied to the nozzle 650 through the supply pipe 663 from the cleaning liquid supply source R1 or the rinse liquid supply source R2. The cleaning liquid or the rinse liquid is thus supplied to a surface of the substrate W. Examples of the cleaning liquid may include pure water, a pure water solution containing a complex (ionized), or a fluorine-based chemical solution. Examples of the rinse liquid may include pure water, carbonated water, hydrogen water, electrolytic ionic water, and HFE (hydrofluoroether).

A second rotation motor 671 is arranged outside the spin chuck 621. The second rotation motor 671 is connected to a second rotation shaft 672. The second rotation shaft 672 is coupled to a second arm 673, which extends in the horizontal direction, and whose end is provided with a nozzle 670 for drying processing.

The second rotation shaft 672 is rotated by the second rotation motor 671, so that the second arm 673 swings. This causes the nozzle 670 to move above the substrate W held on the spin chuck 621.

A supply pipe 674 for drying processing is arranged so as to pass through the inside of the second rotation motor 671, second rotation shaft 672, and second arm 673. The supply pipe 674 is connected to an inert gas supply source R3 through a valve Vc. Controlling the opening and closing of the valve Vc allows adjustments to be made to the amount of the inert gas supplied to the supply pipe 674.

The inert gas is supplied to the nozzle 670 through the supply pipe 674 from the inert gas supply source R3. The inert gas is thus supplied to the surface of the substrate W. Nitrogen gas (N₂), for example, may be used as the inert gas.

When supplying the cleaning liquid or the rinse liquid onto the surface of the substrate W, the nozzle 650 is positioned above the substrate. When supplying the inert gas onto the surface of the substrate W, the nozzle 650 is retracted to a predetermined position.

When supplying the cleaning liquid or the rinse liquid onto the surface of the substrate W, the nozzle 670 is retracted to a predetermined position. When supplying the inert gas onto the surface of the substrate W, the nozzle 670 is positioned above the substrate W.

The substrate W held on the spin chuck 621 is housed in a processing cup 623. A cylindrical partition wall 633 is provided inside the processing cup 623. A discharge space 631 is formed so as to surround the spin chuck 621 for discharging the processing liquid (i.e., cleaning liquid or rinse liquid) used in processing the substrate W. Also, a liquid recovery space 632 is formed between the processing cup 623 and the partition wall 633, so as to surround the discharge space 631, for recovering the processing liquid used in processing the substrate W.

The discharge space 631 is connected with a discharge pipe 634 for directing the processing liquid to a liquid discharge processing device (not shown), while the liquid recovery space 632 is connected with a recovery pipe 635 for directing the processing liquid to a recovery processing device (not shown).

A guard 624 is provided above the processing cup 623 for preventing the processing liquid on the substrate W from splashing outward. The guard 624 is configured to be rotation-symmetric with respect to the rotation shaft 625. A liquid discharge guide groove 641 with a V-shaped cross section is formed in a circular shape inwardly of an upper end portion of the guard 624.

Also, a liquid recovery guide 642 having an inclined surface that inclines down outwardly is formed inwardly of a lower portion of the guard 624. A partition wall housing groove 643 for receiving the partition wall 633 in the processing cup 623 is formed in the vicinity of the upper end of the liquid recovery guide 642.

This guard 624 is provided with a guard lifting mechanism (not shown) composed of a ball screw mechanism or the like. The guard lifting mechanism lifts and lowers the guard 624 between a recovery position in which the liquid recovery guide 642 is positioned opposite to outer edges of the substrate W held on the spin chuck 621 and a discharge position in which the liquid discharge guide groove 641 is positioned opposite to the outer edges of the substrate W held on the spin chuck 621. When the guard 624 is in the recovery position (i.e., the position of the guard shown in FIG. 4), the processing liquid splashed out from the substrate W is directed by the liquid recovery guide 642 to the liquid recovery space 632, and then recovered through the recovery pipe 635. On the other hand, when the guard 624 is in the discharge position, the processing liquid splashed out from the substrate W is directed by the liquid discharge guide groove 641 to the discharge space 631, and then discharged through the discharge pipe 634. With the above-described configuration, discharge and recovery of the processing liquid is performed.

The processing operation of the drying processing unit DRY having the above-described configuration is next described. Note that the operation of each component in the drying processing unit DRY described below is controlled by the main controller 30 in FIG. 1.

When the substrate W is initially carried into the drying processing unit DRY, the guard 624 is lowered, and the fifth central robot CR5 in FIG. 1 places the substrate W onto the spin chuck 621. The substrate W on the spin chuck 621 is held by suction.

Next, the guard 624 moves to the aforementioned discharge position, and the nozzle 650 moves above the center of the substrate W. Then, the rotation shaft 625 rotates, causing the substrate W held on the spin chuck 621 to rotate. After this, the cleaning liquid is discharged onto the top surface of the substrate W from the nozzle 650. This provides cleaning of the substrate W. Note that the supply of the cleaning liquid onto the substrate W may be executed by a soft spray method using a two-fluid nozzle.

After the elapse of a predetermined time, the supply of the cleaning liquid is stopped, and the rinse liquid is discharged from the nozzle 650. The cleaning liquid on the substrate W is thus cleaned away.

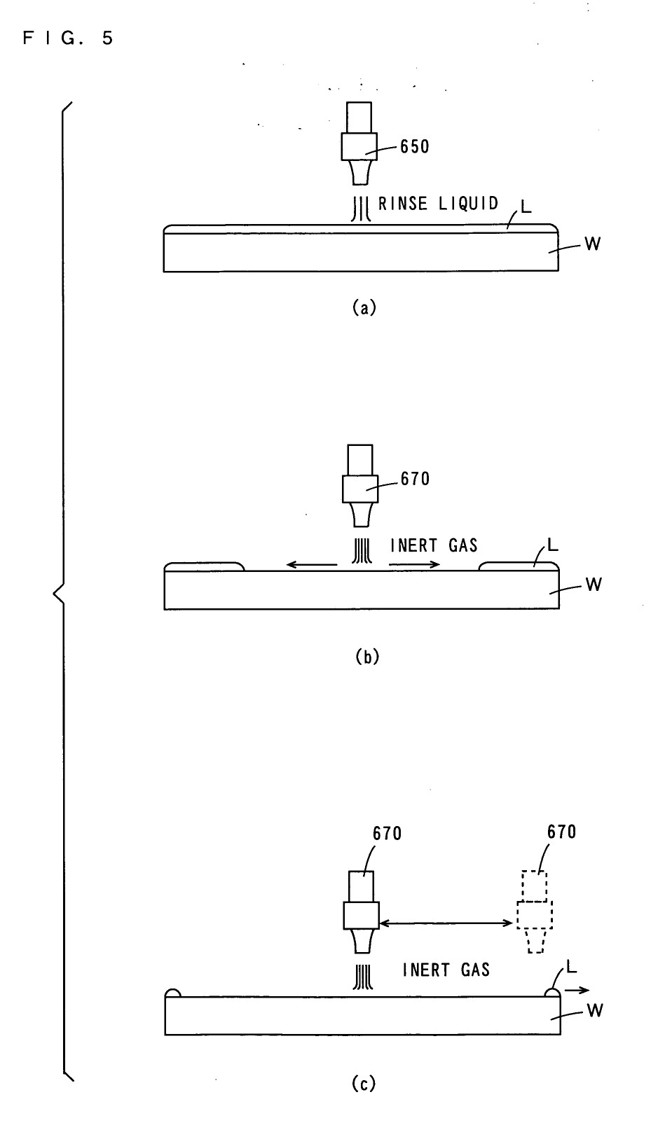

After the elapse of another predetermined time, the rotation speed of the rotation shaft 625 decreases. This reduces the amount of the rinse liquid that is shaken off by the rotation of the substrate W, resulting in the formation of a liquid layer L of the rinse liquid over the entire surface of the substrate W, as shown in FIG. 5(a). Alternatively, the rotation of the rotation shaft 625 may be stopped to form the liquid layer L over the entire surface of the substrate W.

The embodiment employs the configuration in which the nozzle 650 is used for supplying both the cleaning liquid and the rinse liquid, so as to supply both the cleaning liquid and the rinse liquid from the nozzle 650. However, a configuration may also be employed in which nozzles are separately provided for supplying the cleaning liquid and the rinse liquid.

In order to prevent the rinse liquid from flowing to the back surface of the substrate W during the supply of the rinse liquid, pure water may be supplied to the back surface of the substrate W from a back rinsing nozzle (not shown).

Note that when using pure water as the cleaning liquid for cleaning the substrate W, it is not necessary to supply the rinse liquid.

The supply of the rinse liquid is subsequently stopped, and the nozzle 650 retracts to the predetermined position while the nozzle 670 moves above the center of the substrate W. The inert gas is subsequently discharged from the nozzle 670. This causes the rinse liquid around the center of the substrate W to move toward a peripheral portion of the substrate W, leaving the liquid layer L only on the peripheral portion, as shown in FIG. 5(b).

Next, as the number of revolutions of the rotation shaft 625 (see FIG. 4) increases, the nozzle 670 gradually moves from above the center of the substrate W to above the peripheral portion thereof, as shown in FIG. 5(c). This causes a great centrifugal force acting on the liquid layer L on the substrate W while allowing the inert gas to be sprayed toward the entire surface of the substrate W, thereby ensuring the removal of the liquid layer L on the substrate W. As a result, the substrate W can be reliably dried.

Then, the supply of the inert gas is stopped, and the nozzle 670 retracts to the predetermined position while the rotation of the rotation shaft 625 is stopped. After this, the guard 624 is lowered, and the fifth central robot CR5 in FIG. 1 carries the substrate W out of the drying processing unit DRY. The processing operation of the drying processing unit DRY is thus completed.

It is preferred that the position of the guard 624 during cleaning and drying processing is suitably changed according to the necessity of the recovery or discharge of the processing liquid.

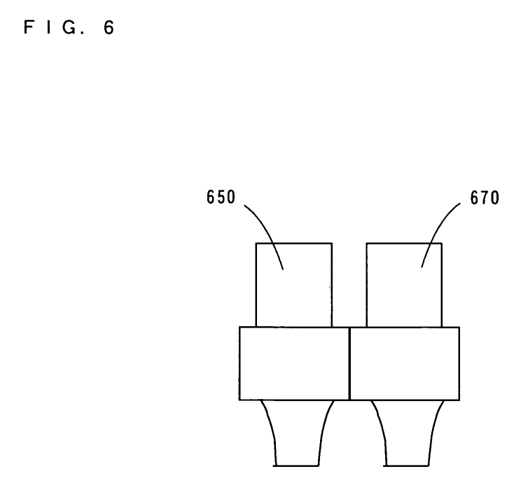

Although the drying processing unit DRY shown in FIG. 4 includes the nozzle 650 for cleaning processing and the nozzle 670 for drying processing separately, the nozzle 650 and the nozzle 670 may also be formed integrally, as shown in FIG. 6. This obviates the need to move each of the nozzle 650 and the nozzle 670 separately during the cleaning or drying processing to the substrate W, thereby simplifying the driving mechanism.

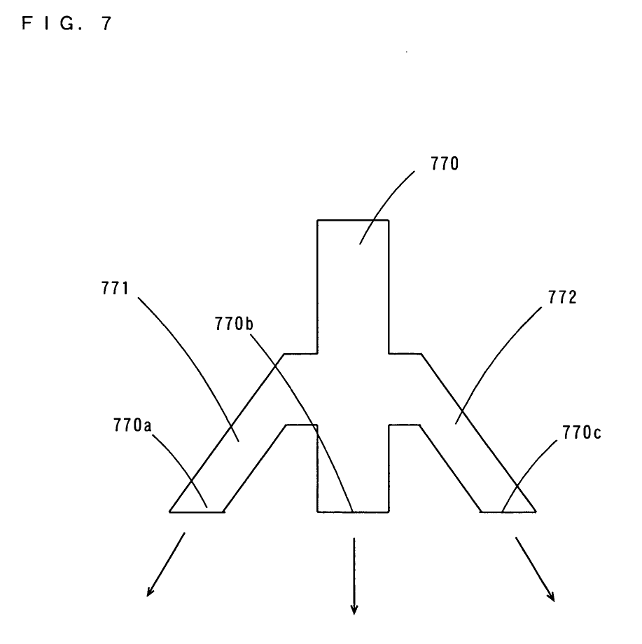

A nozzle 770 for drying processing as shown in FIG. 7 may also be used instead of the nozzle 670 for drying processing.

The nozzle 770 in FIG. 7 extends vertically downward, and also has branch pipes 771, 772 that extend obliquely downward from sides thereof. A gas discharge port 770a is formed at the lower end of the branch pipe 771, a gas discharge port 770b is formed at the lower end of the nozzle 770, and a gas discharge port 770c is formed at the lower end of the branch pipe 772, each for discharging an inert gas. The discharge port 770b discharges an inert gas vertically downward, and the discharge ports 770a, 770c each discharge an inert gas obliquely downward, as indicated by the arrows in FIG. 7. That is to say, the nozzle 770 discharges the inert gas so as to increase the spraying area downwardly.

Now, a drying processing unit DRY using the nozzle 770 for drying processing applies drying processing to the substrate W as will be described below.

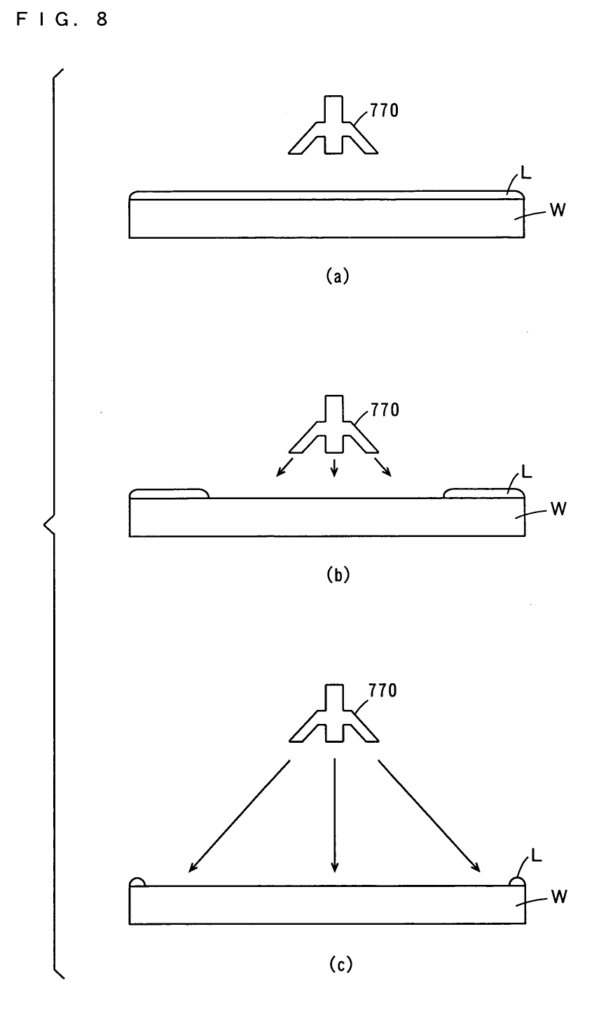

FIGS. 8(a), 8(b), 8(c) are diagrams for use in illustrating a method of applying drying processing to the substrate W using the nozzle 770.

Initially, a liquid layer L is formed on the surface of the substrate W by the method as described in FIG. 5(a), and then the nozzle 770 moves above the center of the substrate W, as shown in FIG. 8(a). After this, an inert gas is discharged from the nozzle 770. This causes the rinse liquid on the center of the substrate W to move to the peripheral portion of the substrate W, leaving the liquid layer L only on the peripheral portion of the substrate W, as shown in FIG. 8(b). At the time, the nozzle 770 is brought close to the surface of the substrate W so as to reliably move the rinse liquid present on the center of the substrate W.

Next, as the number of revolutions of the rotation shaft 625 (see FIG. 4) increases, the nozzle 770 moves upward as shown in FIG. 8(c). This causes a great centrifugal force acting on the liquid layer L on the substrate W while increasing the area to which the inert gas is sprayed on the substrate W. As a result, the liquid layer L on the substrate W is reliably removed. Note that the nozzle 770 can be moved up and down by lifting and lowering the second rotation shaft 672 via a rotation shaft lifting mechanism (not shown) provided to the second rotation shaft 672 in FIG. 4.

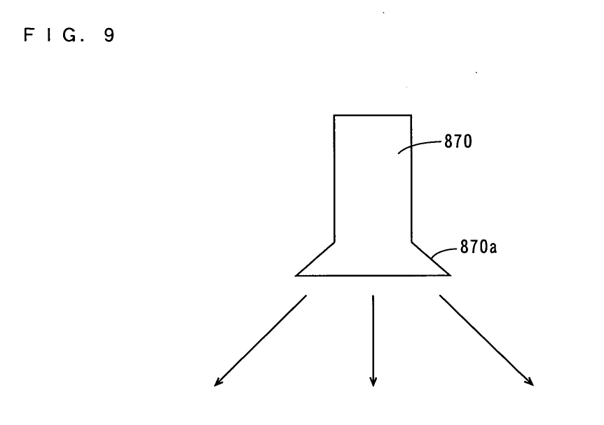

Alternatively, a nozzle 870 for drying processing as shown in FIG. 9 may be used instead of the nozzle 770. The nozzle 870 in FIG. 9 has a discharge port 870a whose diameter gradually increases downward. This discharge port 870a discharges an inert gas vertically downward and obliquely downward as indicated by the arrows in FIG. 9. That is, similarly to the nozzle 770 in FIG. 7, the nozzle 870 discharges the inert gas so as to increase the spraying area downwardly. Consequently, drying processing similar to that using the nozzle 770 can be applied to the substrate W using the nozzle 870.

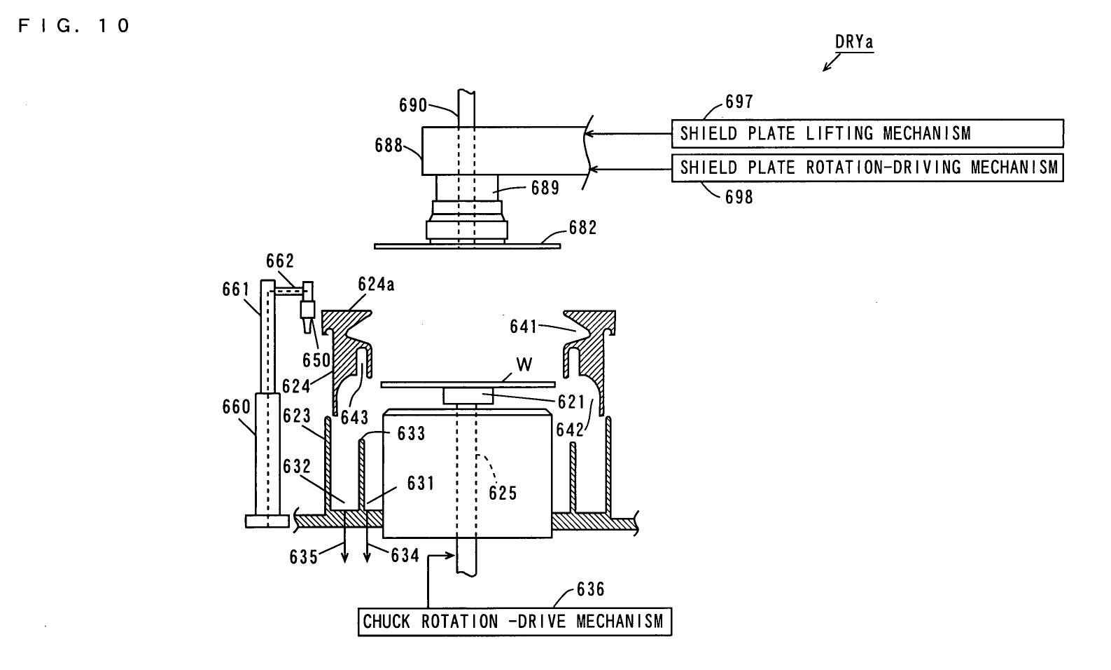

A drying processing unit DRYa as shown in FIG. 10 may also be used instead of the drying processing unit DRY shown in FIG. 4.

The drying processing unit DRYa in FIG. 10 is different from the drying processing unit DRY in FIG. 4 as described below.

The drying processing unit DRYa in FIG. 10 includes above the spin chuck 621 a disk-shaped shield plate 682 having an opening through the center thereof. A support shaft 689 extends vertically downward from around an end of an arm 688, and the shield plate 682 is mounted at a lower end of the support shaft 689 so as to oppose the top surface of the substrate W held on the spin chuck 621.

A gas supply passage 690 that communicates with the opening of the shield plate 682 is inserted into the inside of the support shaft 689. A nitrogen gas (N₂), for example, is supplied into the gas supply passage 690.

The arm 688 is connected with a shield plate lifting mechanism 697 and a shield plate rotation-driving mechanism 698. The shield plate lifting mechanism 697 lifts and lowers the shield plate 682 between a position close to the top surface of the substrate W held on the spin chuck 621 and a position upwardly away from the spin chuck 621.

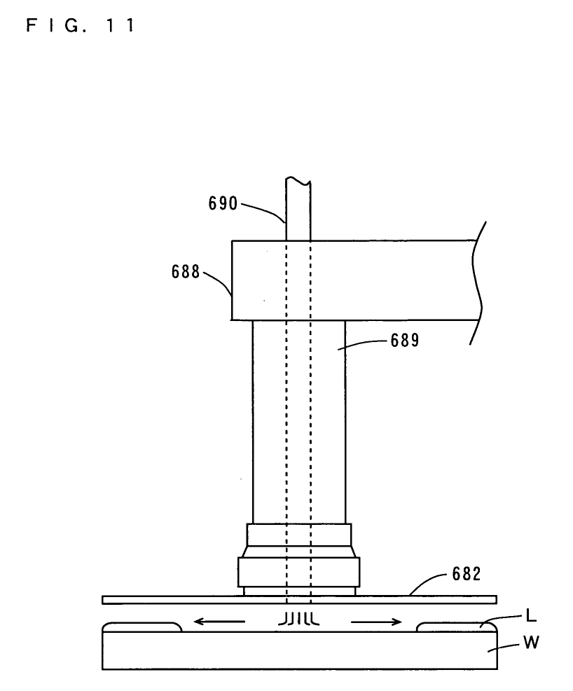

During the drying processing to the substrate W in the drying processing unit DRYa in FIG. 10, with the shield plate 682 brought close to the substrate W as shown in FIG. 11, an inert gas is supplied to clearance between the substrate W and the shield plate 682 from the gas supply passage 690. This allows the inert gas to be efficiently supplied from the center of the substrate W to the peripheral portion thereof, thereby ensuring the removal of the liquid layer L on the substrate W.

Although in the above-described embodiment, the substrate W is subjected to the drying processing by spin drying in the drying processing unit DRY, the substrate W may be subjected to the drying processing by other methods such as a reduced pressure drying method or an air knife drying method.

Although in the above-described embodiment, the inert gas is supplied from the nozzle 670 with the liquid layer L of the rinse liquid being formed, the following method may be applied when the liquid layer L of the rinse liquid is not formed or the rinse liquid is not used. That is, the liquid layer of cleaning liquid is shaken off once by rotating the substrate W, and an inert gas is then immediately supplied from the nozzle 670 to thoroughly dry the substrate W.

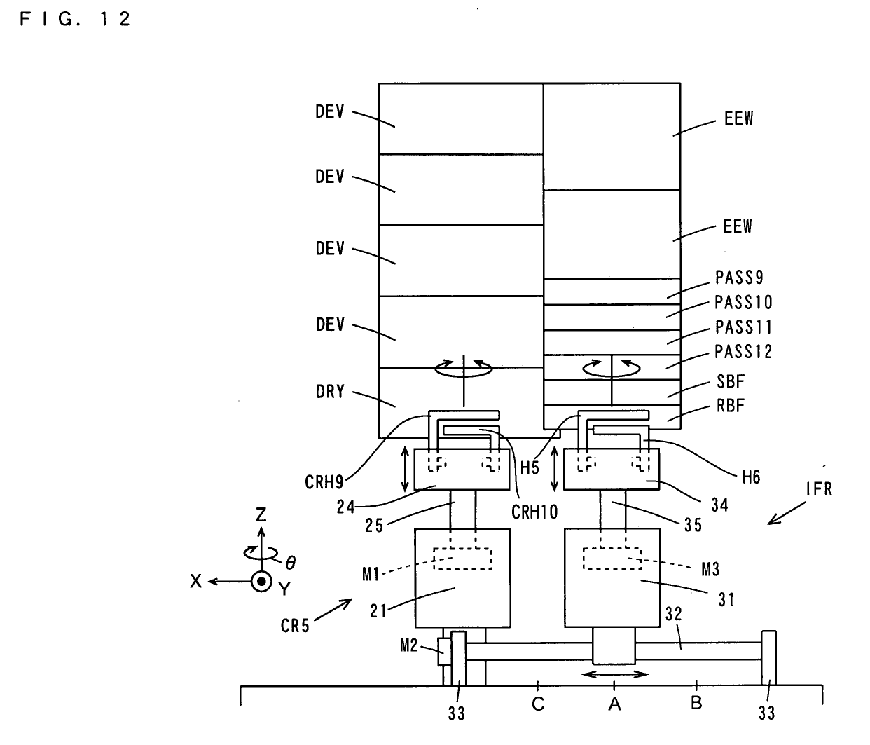

The fifth central robot CR5 and the interface transport mechanism IFR are next described in detail. FIG. 12 is a diagram for use in illustrating the configuration and operation of the fifth central robot CR5 and the interface transport mechanism IFR.

The configuration of the fifth central robot CR5 is first described. As shown in FIG. 12, a hand support base 24 is mounted to a securing base 21 of the fifth central robot CR5 so as to rotate in the ±θ direction while moving up and down in the ±Z direction. The hand support base 24 is coupled to a motor Ml in the securing base 21 through a rotation shaft 25, and rotated by the motor M1. Two hands CRH9, CRH10 for holding the substrate W in a horizontal attitude are mounted to the hand support base 24 one above the other, so as to move forward and backward.

The configuration of the interface transport mechanism IFR is next described. The movable base 31 in the interface transport mechanism IFR is threadably mounted to a screwed shaft 32. The screwed shaft 32 is rotatably supported with support bases 33 so as to extend in the X direction. One end of the screwed shaft 32 is provided with a motor M2, which causes the screwed shaft 32 to rotate and the movable base 31 to horizontally move in the ±X direction.

A hand support base 34 is mounted on the movable base 31 so as to rotate in the ±θ direction while moving up and down in the ±Z direction. The hand support base 34 is coupled to a motor M3 in the movable base 31 through a rotation shaft 35, and rotated by the motor M3. Two hands H5, H6 for holding the substrate W in a horizontal attitude are mounted to the hand support base 34 one above the other, so as to move forward and backward.

The operation of the fifth central robot CR5 and the interface transport mechanism IFR is next described. The operation of the fifth central robot CR5 and the interface transport mechanism IFR is controlled by the main controller 30 in FIG. 1.

The fifth central robot CR5 initially rotates the hand support base 24 while lifting the hand support base 24 in the +Z direction, to allow the upper hand CRH9 to enter the substrate platform PASS9. When the hand CRH9 has received the substrate W in the substrate platform PASS9, the fifth central robot CR5 retracts the hand CRH9 from the substrate platform PASS9.

The fifth central robot subsequently lowers the hand support base 24 in the −Z direction. After this, the fifth central robot CR5 allows the hand CRH9 to enter the feed buffer SBF, and carries the substrate W to the feed buffer SBF while receiving the substrate W treated in advance.

Then, the fifth central robot CR5 retracts the hand CRH9, and lowers the hand support 24 in the +Z direction. The fifth central robot CR5 subsequently allows the hand CRH9 to enter the substrate platform PASS11, and transfer the substrate W therein.

Then, the interface transport mechanism IFR rotates the hand support base 34 at the position A while lifting the hand support base 34 in the +Z direction, to allow the upper hand H5 to enter the substrate platform PASS11. When the hand H5 has received the substrate W in the substrate platform PASS11, the interface transport mechanism IFR retracts the hand H5 from the substrate platform PASS11, and lowers the hand support base 34 in the −Z direction.

The interface transport mechanism IFR subsequently moves in the −X direction, and rotates the hand support base 34 at the position B while allowing the hand H5 to enter a substrate inlet 14a (see FIG. 1) in the exposure device 14. After the hand H5 has carried the substrate W into the substrate inlet 14a, the interface transport mechanism IFR retracts the hand H5 from the substrate inlet 14a.

Then, the interface transport mechanism IFR moves in the +X direction, and allows the lower hand H6 to enter a substrate outlet 14b (see FIG. 1) in the exposure device 14 at the position C. When the hand H6 has received the substrate W after the exposure processing from the substrate outlet 14b, the interface transport mechanism IFR retracts the hand H6 from the substrate outlet 14b.

The interface transport mechanism IFR subsequently moves in the −X direction, and rotates the hand support base 34 at the position A while lifting the hand support base 34 in the +Z direction. After this, the interface transport mechanism IFR allows the hand H6 to enter the substrate platform PASS12, and transfer the substrate W therein.

Then, the fifth central robot CR5 allows the lower hand CRH10 to enter the substrate platform PASS12. When the hand CRH10 has received the substrate W in the substrate platform PASS12, the fifth central robot CR5 retracts the hand CRH10 from the substrate platform PASS12.

The fifth central robot CR5 subsequently rotates the hand support base 24, and allows the hand CRH9 to enter the drying processing unit DRY. When the hand CRH9 has received the dried substrate W treated in advance in the drying processing unit DRY, the fifth central robot CR5 retracts the hand CRH9 from the drying processing unit DRY while allowing the hand CRH10 to enter the drying processing unit DRY. After the hand CRH10 has carried the substrate W into the drying processing unit DRY, the fifth central robot CR5 retracts the hand CRH10 from the drying processing unit DRY.

The fifth central robot CR5 then lifts the hand support base 24 in the +Z direction while rotating the hand support base 24, to allow the hand CRH9 to enter the substrate platform PASS10, and transfer the substrate W therein.

As described above, in this embodiment, the substrate W after the exposure processing is dried by the drying processing unit DRY, and then transported to the thermal processing groups 121 by the fourth central robot CR4. This prevents the liquid on the substrate W after the exposure processing from attaching to the fourth central robot CR4.

Moreover, the fifth central robot CR5 employs the upper hand CRH9 during the transport of the substrate W from the substrate platform PASS9 to the feed buffer SBF, from the feed buffer SBF to the substrate platform PASS11, and from a drying processing unit DRY to the substrate platform PASS10, and employs the lower hand CRH10 during the transport of the substrate W from the substrate platform PASS12 to a drying processing unit DRY. That is, the upper hand CRH9 holds the substrate W during the transport of the substrate W to which a liquid is not attached before the exposure processing and after the drying processing, while the lower hand CRH10 holds the substrate W during the transport of the substrate W to which a liquid is attached after the exposure processing and before the drying processing. This prevents the liquid on the substrate W after the exposure processing from attaching to the hand CRH9.

Furthermore, the interface transport mechanism IFR employs the upper hand H5 during the transport of the substrate W from the substrate platform PASS11 to the exposure device 14, and employs the lower hand H6 during the transport of the substrate W from the exposure device 14 to the substrate platform PASS12. That is, the upper hand H5 holds the substrate W during the transport of the substrate W to which a liquid is not attached before the exposure processing, while the lower hand H6 holds the substrate W during the transport of the substrate W to which a liquid is attached immediately after the exposure processing. This prevents the liquid on the substrate W after the exposure processing from attaching to the hand H5.

As a result of the foregoing, a liquid is prevented from attaching to the substrate W before the exposure processing, which sufficiently prevents contamination of the back surface of the substrate W due to the attachment of particles and the like to the liquid. It is thus possible to prevent processing defects due to degradation in the resolution performance or the like in the exposure device 14.

Although in this embodiment, the hand CRH10 is arranged below the hand CRH9, so that even if a liquid drops from the hand CRH10 and the substrate W held thereon, the liquid will not attach to the hand CRH9 and the substrate W held thereon.

Moreover, the hand H6 is arranged below the hand H5, so that even if a liquid drops from the hand H6 and the substrate W held thereon, the liquid will not attach to the hand H5 and the substrate W held thereon.

As a result of the foregoing, a liquid is reliably prevented from attaching to the substrate W before the exposure processing, which reliably prevents contamination of the substrate W.

Furthermore, in this embodiment, the substrate W is subjected to the drying processing by a drying processing unit DRY after the exposure processing. This prevents a liquid from dropping in the substrate processing apparatus 500 as the substrate W is carried from the drying processing unit DRY to the interface block 13, drying/development processing block 12, resist film processing block 11, anti-reflection film processing block 10, and indexer block 9. As a result, in the substrate processing apparatus 500, operational troubles such as abnormalities in the electric system are prevented.

Moreover, the drying processing unit DRY applies the drying processing to the substrate W by spraying the inert gas onto the substrate W from the center to the peripheral portion thereof while rotating the substrate W. This ensures that the cleaning liquid and the rinse liquid are removed from the substrate W, which reliably prevents the attachment of particles and the like in the atmosphere on the cleaned substrate W. It is thus possible to reliably prevent the contamination of the substrate W and the generation of dry marks on the surface of the substrate W.

Also, it is possible to reliably prevent the cleaning liquid and the rinse liquid from remaining on the cleaned substrate W, which reliably prevents further elution of the resist component in the cleaning liquid and the rinse liquid during the transport of the substrate W from the drying processing unit DRY to the development processing group 90. This prevents the deformation of an exposure pattern formed on the resist film. As a result, the accuracy of line width can be reliably prevented from decreasing during the development processing.

Further, the drying processing unit DRY applies the cleaning processing to the substrate W before the drying processing. Thus, even if a liquid attaches to the substrate during exposure, and particles and the like in the atmosphere adhere to the substrate during the transport of the substrate W from the exposure device 14 to the drying processing unit DRY, the deposits can be reliably removed.

As a result of the foregoing, processing defects of the substrate W are prevented reliably.

Although, in this embodiment, the substrate W that has been transferred onto the substrate platform PASS9 from the edge exposure units EEW is sequentially transported to the feed buffer SBF, the substrate platform PASS11 and the exposure device 14, the substrate W may be transported from the substrate platform PASS9 to the exposure device 14 if there is not enough space to provide the feed buffer SBF and the substrate platform PASS11.

Moreover, in this embodiment, the single interface transport mechanism IFR is used for transporting the substrate W from the substrate platform PASS11 to the exposure device 14, and from the exposure device 14 to the substrate platform PASS12, plurality of interface transport mechanisms IFR may also be used for transporting the substrate W.

Furthermore, the numbers of the coating units BARC, RES, the development processing units DEV, the drying processing units DRY, the cooling units CP, and the heating units HP may suitably be changed according to the processing speed of each processing block.

In this embodiment, each of the anti-reflection film processing block 10, the resist film processing block 11, and the drying/development processing block 12 corresponds to a processing section; the interface block 13 corresponds to an interface; each of the drying processing units DRY, DRYa corresponds to a first processing unit; each of the edge exposure units EEW corresponds to a second processing unit; each of the coating units RES corresponds to a third processing unit; each of the substrate platforms PASS9, PASS10, PASS11, PASS12, the feed buffer SBF, and the return buffer RBF corresponds to a platform; the fourth central robot CR4 corresponds to a first transport unit; the interface transport mechanism IFR corresponds to a second transport unit; and the fifth central robot CR5 corresponds to a third transport unit.

The hand H5 corresponds to a first holder; the hand H6 corresponds to a second holder; the hand CRH9 corresponds to a third holder; the hand CRH10 corresponds to a fourth holder; each of the coating units BARC, RES, and the development processing units DEV corresponds to a chemical solution processing unit; and each of the cooling units CP and the heating units HP corresponds to a thermal processing unit.

The spin chuck 621 corresponds to a substrate holding device; the rotation shaft 625 and the chuck rotation-drive mechanism 636 correspond to a rotation-driving device; the nozzle 650 for cleaning processing corresponds to a cleaning liquid supplier and a rinse liquid supplier; and each of the nozzles 670, 770, 870 for drying processing corresponds to an inert gas supplier.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A substrate processing apparatus that is arranged adjacent to an exposure device, comprising:
a processing section for applying processing to a substrate; and
an interface for exchanging the substrate between said processing section and said exposure device, wherein
said processing section includes a first processing unit that dries the substrate,
said interface includes:
a platform on which the substrate is temporarily mounted;
a first transport unit that transports the substrate between said processing section and said platform;
a second transport unit that transports the substrate between said platform and said exposure device; and
a third transport unit that transports the substrate between said platform and said first processing unit, and wherein
said second transport unit includes first and second holders for holding the substrate, and holds the substrate with said first holder during the transport of the substrate from said platform to said exposure device, and holds the substrate with said second holder during the transport of the substrate from said exposure device to said platform,
said third transport unit includes third and fourth holders for holding the substrate, and holds the substrate with said third holder during the transport of the substrate from said first processing unit to said platform, and holds the substrate with said fourth holder during the transport of the substrate from said platform to said first processing unit.

2. The substrate processing apparatus according to claim 1, wherein
said second holder is provided below said first holder.

3. The substrate processing apparatus according to claim 1, wherein
said fourth holder is provided below said third holder.

4. The substrate processing apparatus according to claim 1, wherein
said interface further includes a second processing unit that applies given processing to the substrate, and
said first transport unit transports the substrate between said processing section, said second processing unit, and said platform.

5. The substrate processing apparatus according to claim 4, wherein
said second processing unit includes an edge exposure unit for subjecting a peripheral portion of the substrate to exposure.

6. The substrate processing apparatus according to claim 1, wherein
said processing section further includes a third processing unit that forms a photosensitive film made of a photosensitive material on the substrate.

7. The substrate processing apparatus according to claim 1, wherein
said first processing unit further cleans the substrate before drying the substrate.

8. The substrate processing apparatus according to claim 7, wherein
said first processing unit comprises:
a substrate holding device that holds the substrate substantially horizontally;
a rotation-driving device that rotates the substrate held on said substrate holding device about an axis vertical to the substrate;
a cleaning liquid supplier that supplies a cleaning liquid onto the substrate held on said substrate holding device; and
an inert gas supplier that supplies an inert gas onto the substrate after the cleaning liquid has been supplied onto the substrate by said cleaning liquid supplier.

9. The substrate processing apparatus according to claim 8, wherein
said inert gas supplier supplies the inert gas so that the cleaning liquid supplied onto the substrate from said cleaning liquid supplier is removed from the substrate as the cleaning liquid moves outwardly from the center of the substrate.

10. The substrate processing apparatus according to claim 8, wherein
said first processing unit further comprises a rinse liquid supplier that supplies a rinse liquid onto the substrate after the supply of the cleaning liquid from said cleaning liquid supplier and before the supply of the inert gas from said inert gas supplier.

11. The substrate processing apparatus according to claim 10, wherein
said inert gas supplier supplies the inert gas so that the rinse liquid supplied onto the substrate from said rinse liquid supplier is removed from the substrate as the rinse liquid moves outwardly from the center of the substrate.

12. The substrate processing apparatus according to claim 1, wherein
said processing section includes a chemical solution processing unit that treats the substrate with a chemical solution, and a thermal processing unit that thermally treats the substrate.

13. A substrate processing method for processing a substrate in a substrate processing apparatus that is arranged adjacent to an exposure device and comprises a processing section, a first transport unit, a second transport unit that includes first and second holders, a third transport unit that includes third and fourth holders, a first processing unit, and a platform, comprising the steps of:
applying given processing to a substrate by said processing section;
transporting the substrate that has been processed by said processing section to said platform by means of said first transport unit;
transporting the substrate from said platform to said exposure device while holding the substrate by said first holder of said second transport unit;
transporting the substrate that has been carried out of said exposure device to said platform while holding the substrate by said second holder of said second transport unit;
transporting the substrate from said platform to said first processing unit while holding the substrate by said fourth holder of said third transport unit;
drying the substrate by said first processing unit;
transporting the substrate that has been carried out of said first processing unit to said platform while holding the substrate by said third holder of said third transport unit; and
transporting the substrate from said platform to said processing section by means of said first transport unit.

14. The substrate processing method according to claim 13, further comprising the step of cleaning the substrate by said first processing unit, after said step of transporting the substrate from said platform to said first processing unit by said third transport unit and before said step of drying the substrate by said first processing unit.
